(19) United States
(12) Patent Application Publication
(10) Pub. No.: US 2026/0163847 A1
(43) Pub. Date: Jun. 11, 2026

(54) METHODS AND SYSTEMS FOR EMOTIVE AND CONTEXTUAL MESSAGING

(71) Applicant: OnePIN, Inc., Westborough, MA (US)

(72) Inventors: Feyzi Celik, Hopkinton, MA (US); Andrea Goodwin, Fryeburg, ME (US); David Moore, Lexington, MA (US)

(73) Assignee: OnePIN, Inc., Westborough, MA (US)

(21) Appl. No.: 18/707,541

(22) PCT Filed: Nov. 4, 2022
(86) PCT No.: PCT/US2022/048982

§ 371 Date: May 3, 2024

Related U.S. Application Data
(60) Provisional application No. 63/275,546, filed on Nov. 4, 2021.

(51) Int. Cl. H04L 51/02; H04M 1/72436; H04W 4/14; H04W 4/24

(52) U.S. Cl. CPC H04L 51/02; H04M 1/72436; H04W 4/14; H04W 4/24

(57) ABSTRACT

Systems and methods provide mobile users with the ability to express themselves beyond their initial SMS or phone call. Automated systems and messages enable user devices to select and send an emoji, message, quote, or joke to send to a second mobile device following a disconnected call or other trigger event. After a triggering event occurs, the SIM Card will communicate with a cloud server using the mobile network. Intelligence within the cloud server determines what type of message, such as an emoji or uplifting phrase, to present to the mobile device. The cloud server has the intelligence to determine the appropriate content based on the triggering event type.

### FIELD

This disclosure relates to the field of communications, and specifically, to the use of mobile messaging services for expressing emotions to others.

### BACKGROUND

Many mobile devices have the ability to initiate either circuit-switched or data calls and to enable various types of message sending between users. It is becoming increasingly important to be able to communicate with both forms (calling and messaging) between mobile users. SMS messaging is now one of the most preferred ways to interact because of its ease and facility to share information quickly. It is also desirable because SMS messaging can be done in any geographic location or time. Therefore, the ability to connect quickly with people and share thoughts and feelings as seamlessly as possible is critical for today's world.

One of the main challenges with utilizing messaging is that it takes time to write messages and send them to other parties. Creating an SMS message or an email is time-consuming and tedious. Advances in technology have also made communications between people more impersonal and callers cannot connect with others as easily. This makes it challenging to share emotions and relate to one another. Thus, there is a need for a way to allow mobile users to quickly and easily share emotions and feelings.

### SUMMARY

In one aspect, this disclosure provide a system for automatically sending a plurality of expressive message options after a call from a mobile device to a second mobile device has disconnected. The system comprises a SIM application installed on a SIM card of the mobile device and configured to: detect that, or receive an indication that, a call from the mobile device to the second mobile device has disconnected; prepare a communication comprising the originating address of the mobile device, the destination address of the second mobile device, and an SMSC short code; and send the communication to a cloud server operably connected to a Mobile Network Operator's (MNO) network via Short Message Service Center (SMSC). In some embodiments, the SMSC is operated or controlled by the MNO.

The system also comprises a Short Message Service Center (SMSC) operably connected to the MNO's network and configured to: send the communication to a cloud server operably connected to the SMSC; send to the mobile device a message received from the cloud server; receive a second communication from the SIM application, the second communication comprising a selected expressive message option selected on the mobile device; and send the second communication comprising the selected expressive message to the cloud server or to the second mobile device.

The system also comprises a cloud server operably connected to the SMSC and configured to: generate a plurality of selectable expressive message options, wherein each expressive message option is an emoji, quote, uplifting message, or event information; prepare a message comprising the plurality of selectable expressive message options and instructions for the SIM application to cause a menu comprising the selectable expressive message options to be displayed on a screen of the mobile device; and send the message to the SMSC.

The system also comprises a billing server operably connected to the SMSC and configured to charge an amount to an account associated with the mobile device when an expressive message is sent to the second mobile device.

In some embodiments, the cloud server is further configured to check a calendar and include a calendar-related message option in the plurality of selectable expressive message options. In some embodiments, the cloud server is further configured to determine if a previous expressive message has been sent from the mobile device to the second mobile device. In certain embodiments, when an expressive message has previously been sent from the mobile device to the second mobile device, the cloud server is further configured to include the previously sent expressive message in the plurality of selectable expressive message options.

In some embodiments, the cloud server is further configured to determine whether the mobile device has opted into receiving the plurality of selectable expressive message options from the cloud server.

In another aspect, this disclosure provides a method of automatically sending automatically sending a plurality of expressive message options after a call from a mobile device to a second mobile device has disconnected. The method comprises receiving, at a Short Messaging Service Center (SMSC) operably connected to a mobile network, a communication from a SIM application on the mobile device, comprising the originating address of the mobile device, the destination address of the second mobile device, and an SMSC short code. The method also comprises sending, from the SMSC, the communication to a cloud server operably connected to the SMSC. The method also comprises generating, at the cloud server, a plurality of selectable expressive message options, wherein each selectable expressive message option is an emoji, quote, uplifting message, or event information; preparing, at the cloud server, a message comprising the plurality of selectable expressive message options and instructions for the SIM application to cause a menu comprising the selectable expressive message options to be displayed on a screen of the mobile device; sending, from the cloud server, the message to the SMSC; sending, from the SMSC, the message to the mobile device; receiving, at the SMSC, a second communication from the mobile device, the second communication comprising a selected expressive message option selected on the mobile device; sending, from the SMSC, the second communication comprising the selected expressive message to the cloud server or to the second mobile device; generating, at a billing server operably connected to the SMSC, an account charge for an account associated with the mobile device when an expressive message is sent to the second mobile device.

In some embodiments, the further comprises checking, by the cloud server, a calendar and including a calendar-related message option in the plurality of selectable expressive message options. In some embodiments, the method also comprises determining, by the cloud server, whether a previous expressive message has been sent from the mobile device from the second mobile device. In certain embodiments, the method further comprises including a previously sent expressive message in the plurality of selectable expressive message options when the cloud server determines that an expressive message has been previously sent from the mobile device to the second mobile device.

In some embodiments, the method comprises determining, by the cloud server, whether the mobile device has opted into receiving the plurality of selectable expressive message options.

One aspect of this disclosure provides a method for sending an emotive or contextual message after a triggering event, the method comprising: detecting that a connected call has disconnected, sending a message to the calling mobile after detecting the call disconnected. In some embodiments, the message is an SMS message. In some embodiments of the method, instead of detecting that a connected call has disconnected, the method comprising detecting that a call from a calling device to a called device was a missed call event. In some embodiments, the disconnected call or missed call event is detected by a network element of a mobile operator. In other embodiments, the disconnected call or missed call event is detected by a cloud server platform operably connected to a mobile operator connected. In still other embodiments, the disconnected call or missed call event is detected at the SIM card in the calling mobile device.

As soon as the trigger event occurs, the SIM Card sends a message to a cloud server platform operably connected to the mobile network. In embodiments of the method occurring at the cloud server platform, the cloud server platform receives a message from a SIM card of the calling mobile device. In some embodiments, the cloud server has intelligence to determine what type of Xpression prompt to present to the mobile user who initiated the call. The cloud server sends a message to the calling mobile device enabling the user of the calling mobile device to select an automated Xpression message to share with the called party. The automated message could be an emoji, a quote, a joke, an uplifting message, or information relating to an upcoming event. Regardless of which selection is chosen, the subscriber will be able to confirm or cancel their decision. The cloud server has the intelligence to determine the appropriate recipient based on the triggering event type. The cloud server also has the ability to store messages sent from the calling device to the called device and learn which messages the user is likely to select after a triggering event. The Xpression message (emoji, quote, joke, uplifting message, or upcoming message) can be sent as an SMS or email message.

In another aspect, this disclosure provides a method for providing emotive and contextual messaging to mobile devices in a mobile network. The method comprising the steps of: receiving trigger information at the Cloud Server from the Operator SMSC Server relating to a first mobile device; sending content to the first mobile device via a digital assistant from the Cloud Server to the Operator SMSC Server; receiving an Xpression from the first mobile device at the Cloud Server from the Operator SMSC server; and forwarding the Xpression from the Cloud Server to the second mobile device.

In some embodiments, the method further comprises the step of sending a request to charge the first mobile device for the Xpression to the Operator SMSC server.

In some embodiments, the method further comprises receiving cancel information from the Operator SMSC server.

In some embodiments, the method further comprises the step of forwarding content via a digital assistant to a first mobile device.

Another aspect of this disclosure provides a system for providing emotive and contextual messaging to one or more mobile devices in a mobile network. The system comprises: a Cloud Server communicatively coupled to a mobile network; an Operator Billing Server, communicatively coupled to the Cloud Server via the mobile network; and an Operator SMSC Server connected to the Cloud Server via the mobile network.

In some embodiments, the system further comprises a first mobile device comprising a first SIM card and a digital assistant, wherein the first mobile device is communicatively coupled to a mobile network.

In some embodiments, the system further comprises a SMSC short code. In some embodiments, the Cloud Server is configured to communicate with a SIM application residing on a SIM card in a mobile device.

### BRIEF DESCRIPTION OF THE FIGURES

These and other features and advantages of this disclosure will be better understood by reading the following detailed description, taken together with the drawings wherein like numerals correspond to like elements or steps throughout the several views.

FIG. 1 is a system diagram illustrating an embodiment of the Communication System.

FIG. 2 is a system diagram of system components within an embodiment of the Communication System.

FIG. 3 is a system diagram of an embodiment of the system structure for the Communication System.

FIG. 4 is a signaling diagram of an embodiment of the communication process.

FIG. 5 is a signaling diagram of the interactive cancel survey in accordance with one embodiment of this disclosure.

FIG. 6 is a table illustrating the editorial calendar in accordance with an embodiment of this disclosure.

FIGS. 7-12 illustrate user interfaces comprising User 1 screens in accordance with embodiments of this disclosure.

FIG. 13-14 illustrate user interfaces comprising User 2 screens in accordance with embodiments of this disclosure.

FIG. 15 illustrates a user interface comprising the interactive cancel survey screens accordance with an embodiment of this disclosure.

### DETAILED DESCRIPTION

While the term “Xpression” is used throughout this disclosure to refer to the methods and systems that provide mobile device users the ability to share emotions, content, quotes, and jokes based on both user and mobile network-initiated triggers, the technology could be offered and referred to under different names. As used herein, the term “Xpression” is not confined to a single embodiment and refers to the systems and methods disclosed herein under any name.

With the systems and methods of this disclosure, mobile users are able to express themselves beyond their initial SMS or phone call. Through these methods and systems of this disclosure, there is now a way to create and maintain the valuable connections with users' contacts. Users are able to select an emoji, message, quote, or joke that will put a smile on a contact's face.

While the term SIM is often used to generically describe any type of subscriber identity management within the mobile industry, this disclosure is inclusive of all SIM technologies including but not limited to USIM, eSIM, iSIM, and SIM. The methods and systems disclosed herein can be deployed in any of these SIM technology environments.

### System Architecture Summary

This disclosure provides a Communication System comprising a User 1 Mobile Device, the Cloud Server, the Operator Billing Server, the Operator SMSC Server, and User 2 Mobile Device.

The Mobile Subscriber 1 Device is the device through which the first user interacts with the Communication System. The terms “Mobile Subscriber 1 Device” and “User 1 Mobile Device” are used interchangeably herein. The terms “Mobile Subscriber 2 Device” and “User 2 Mobile Device” are also used interchangeably herein. Mobile Subscriber 1 Device is configured to display content received from the other components of the Communication System. Mobile Subscriber 1 Device is the originating address for the service disclosed herein. Within the Mobile Subscriber 1 Device is User 1 SIM Card, which collects options selected on the User 1 Mobile Device. The SIM application resides on the User 1 SIM Card and collects information from the User 1 SIM Card to send to the Cloud Server. The term “Digital Assistant” as used herein refers to the SIM application.

The Operator SMSC Server handles SMS communication between User 1 Mobile Device and User 2 Mobile Device. When User 1 chooses an Xpression message to send from User 1 Mobile Device, the Operator SMSC Server collects the information in the SMS message from User 1 Mobile Device and forwards it to User 2 Mobile Device.

The Cloud Server connects the components of the Communication System. In some embodiments, whenever content or information is exchanged between the components, the content or information goes through the Cloud Server.

The Operator Billing Server enables the User 1 Mobile Device to pay for their subscriptions and use of the service. In some embodiments, the Operator Billing Server checks the account associated with User 1 Mobile Device and allows withdrawals from the account to pay for the service.

User 2 Mobile Device is the device to which the User 1 Mobile Device sends the Xpression. User 2 Mobile Device is the destination address for the Xpression messages sent as an SMS message. Within the User 2 Mobile Device is the User 2 SIM Card, which allows for SMS messages to be received by the device. In some embodiments, the SIM application resides within the User 2 SIM card.

### Share an Emoji

After a call has disconnected or been detected as a missed call, or after a text has been sent or a business card or electronic contact card has been sent, the SIM application will display a screen asking whether the user wants to share their feelings or thoughts with User 2. For example, in some embodiments, the screen may read, “Share your feelings with the person you just called?” or, if after a text message or sharing a business card, e.g., “Share your feelings with the person you just contacted?” After the user clicks “OK,” the user will be automatically opted-in to the service and the information is collected by the Cloud Server. Next, the Digital Assistant will display a second screen with a variety of emoji options to choose from. Once the subscriber picks an emoji, the Cloud Server collects their choice and sends a confirmation SMS to them that reads, e.g., “Thank you!“ [symbol] ” was sent successfully to the person you have shared your MTN business card with.” To send the message, the Cloud server collects their choice and communicates with the Mobile Network Operator (“MNO”) SMSC Server to send the emoji to the most destination address in the call log in the form of an SMS message. The Operator SMSC (“Short Message Service Center”) receives this SMS message and forwards it to the destination address. The Mobile Subscriber 2 will receive an SMS message that says (for example) “Your friend 27717578884 shared an emoji with you: [symbol] ”.

In some embodiments, for future calls, the first screen asking if the subscriber would like to opt-in to the service will no longer display on the Mobile Subscriber 1 Mobile Device and the Digital Assistant will directly display the second screen for emoji selection. All other functions of the service remain the same.

### Share a Quote

Once a call is complete and the user sends a text message or business card, the SIM application prompts them with a screen with a quote (Example: We must use time wisely and forever realize that the time is always ripe to do right.—Madiba) and asks: “Send this quote now to the person you just called.” Once the user clicks “Ok,” the Cloud Server stores the information and the user will be opted-in to the service. The Digital Assistant then displays a second screen that reads “Confirm to send this quote to the person you just called for $0.10?” If the subscriber clicks “OK” again, the Cloud Server collects this information and send a confirmation SMS to the subscriber saying, e.g., “Thank you! The quote below was sent successfully to the person you just called. ‘We must use time wisely and forever realize that the time is always ripe to do right.—Madiba’.”

The Cloud Server also communicates with the SIM application on User 1 Mobile Device and sends an SMS message to the most recent person in the call log. The Operator SMSC receives this SMS message and forwards it to the destination address, i.e., the most recent person in the call log. The message will read, e.g., “Your friend 27717578884 shared this quote with you: We must use time wisely and forever realize that the time is always ripe to do right.—Madiba.”

For future calls, the second screen that asks the user to confirm their purchase will not be displayed and, instead, the Cloud Server immediately sends an SMS message after the user confirms the quote displayed in the first screen.

### Share a Joke:

After a call, or sending a text message or business card, the SIM application display the first screen to the user that reads, e.g., “What's the best way to burn 1000 calories? Leave the pizza in the oven. Send this joke now to the person you just called? $0.15.” If the user clicks “OK,” the Cloud Server collects this information and sends an SMS message to the user which read, e.g., “Thank you! The joke below was sent successfully to the person you just called. What's the best way to burn 1000 calories? Leave the pizza in the oven.” The Cloud Server also communicates with the SIM application to send the joke to the Mobile Subscriber 2 Mobile Device. The Operator SMSC receives this SMS message and forwards it to the destination address. This message will read, e.g., “Your friend 27717578884 shared this joke with you: What's the best way to burn 1000 calories? Leave the pizza in the oven.”

### Send a Message:

On a holiday, a weekend, or a new month, once a call is disconnected or missed, the SIM application displays a screen on User 1 Mobile Device that reads, e.g., “It's the weekend! Go enjoy a relaxing few days with the ones you love.′ Send this message to the person you just called? $0.10.” If the user clicks “OK”, the Cloud Server collects this information and sends an SMS message to the user which will read, “Thank you! The message below was sent successfully to the person you just called: It's the weekend! Go enjoy a relaxing few days with the ones you love.” The Cloud Server also communicates with the SIM application to send the message to the Mobile Subscriber 2. The Operator SMSC receives this SMS message and forwards it to the destination address. This message will read, e.g., “Your friend 20717579899 shared this message with you: It's the weekend! Go enjoy a relaxing few days with the ones you love.”

### Share an Uplifting Message:

After a call, or sending a text message or business card, the SIM application displays the first screen on User 1 Mobile Device that reads, e.g., “‘Be confident in yourself and your dreams.’ Send this uplifting message to the person you just called? $0.10.” If the user clicks “OK”, the Cloud Server collects this information and sends an SMS message to the user which will read, “Thank you! The message below was sent successfully to the person you just called: Be confident in yourself and your dreams.” The Cloud Server also communicates with the SIM application to send the uplifting message to the Mobile Subscriber 2. The Operator SMSC receives this SMS message and forwards it to the destination address. This message will read, e.g., “Your friend 20717579899 shared this message with you: Be confident in yourself and your dreams.”

### Send an Upcoming Event:

On a holiday, a weekend, or a new month, once a call is completed the SIM application displays a screen on User 1 Mobile Device that reads, e.g., “‘Support the SA national rugby team tomorrow against Ireland at 10:25. Let's win!’ Send this Upcoming Event message to the person you just called? $0.10.” If the user clicks “OK”, the Cloud Server collects this information and sends an SMS message to the user which will read, “Thank you! The message below was sent successfully to the person you just called: Support the SA national rugby team tomorrow against Ireland at 10:25. Let's win!” The Cloud Server also communicates with the SIM application to send the upcoming event message to the Mobile Subscriber 2. The Operator SMSC receives this SMS message and forwards it to the destination address. This message will read (for example) “Your friend 20717579899 shared this message with you: Support the SA national rugby team tomorrow against Ireland at 10:25. Let's win!”

### Interactive Cancel Options:

If the user clicks “Cancel” on the first screen, the Cloud Server collects the information and displays a set of screens with interactive cancel options. The Digital Assistant will display the first screen that reads “Send this person something else? Send a Joke, Send a Quote, Send an Emoji, Remind me Later, Opt-out”. If the customer clicks “Send a Joke”, “Send a Quote”, or “Send an Emoji” the Cloud Server will collect this information and the Digital Assistant will display the second screen with the appropriate content. If the user clicks “Remind me Later”, the Cloud Server will collect this information and the customer will be contacted again for the service the next day. If the user wants to opt-out of the entire service, they will click “Opt-out.” Once they do this, the customer will no longer be contacted about this service for a certain period of time or permanently.

### System Architecture Illustration

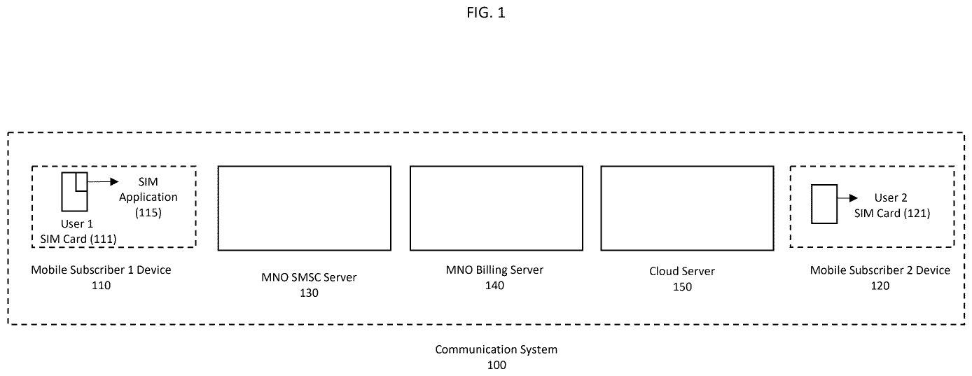

An embodiments of the System Architecture is illustrated in FIG. 1.

Communication System (100) is comprised of Mobile Subscriber 1 Device (110), MNO SMSC Server (130), MNO (MNO refers to a Mobile Network Operator) Billing Server (140), Cloud Server (150), and Mobile Subscriber 2 Device (120).

Mobile Subscriber 1 Device (110) is the device through which a first user interacts with the Communication System (100). Mobile Subscriber 1 Device (110) is configured to display content received from the other components of Communication System (100) and is configured to collect options selected on the user interface of Mobile Subscriber 1 Device (110). Within Mobile Subscriber 1 Device (110) is User 1 SIM Card (111) which collects responses selected on the device, and SIM application (115), which is configured to collect information from User 1 SIM Card (111) and configured to send to the Cloud Server (150).

MNO SMSC Server (130) connects components of the Communication System (100). MNO SMSC Server (130) receives and sends SMS communications between Mobile Subscriber 1 Device (110) and Mobile Subscriber 2 Device (120) and forwards content created by the Cloud Server (150). Cloud Server (150) collects information sent through the Communication System and creates content to be displayed on Mobile Subscriber 1 Device (110) and Mobile Subscriber 2 Device (120). MNO Billing Server (140) collects payments and allows Mobile Subscriber 1 Device (110) to pay for their subscriptions or use of the service. MNO Billing Server (140) checks the user's account associated with Mobile Subscriber 1 Device (110) and allows withdrawals from the account to pay for the service. Mobile Subscriber 2 Device (120) is the device to which Mobile Subscriber 1 Device (110) sends an Xpression message. Mobile Subscriber 2 Device (120) receives the Xpression from Mobile Subscriber 1 Device (110) in the form of an SMS message. Within the User 2 Mobile Device is the User 2 SIM Card (121), which receives the SMS message from Mobile Subscriber 1 Device (110) and causes the message to be displayed on a screen of Mobile Subscriber 2 Device (120).

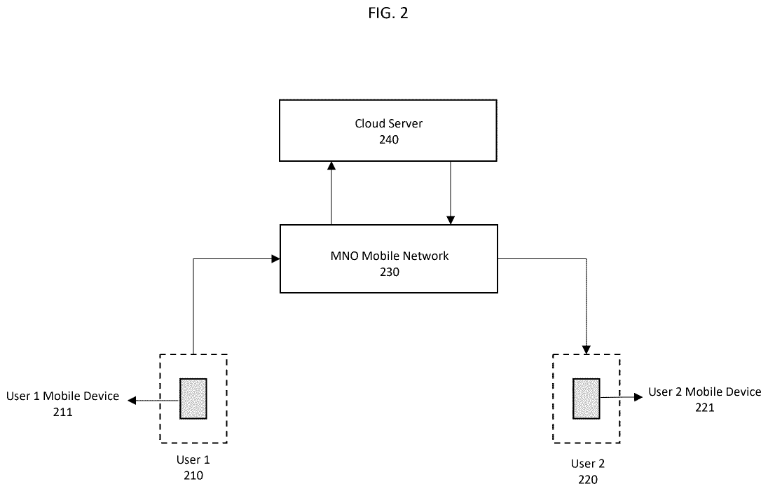

An embodiment of the system components is illustrated in FIG. 2.

The system described in this disclosure allows User 1 (210) to use User 1 Mobile Device (211) to send messages to User 2 (220) at User 2 Mobile Device (221) connected via MNO Mobile Network (230) that is operably connected to Cloud Server (240).

### System Structure

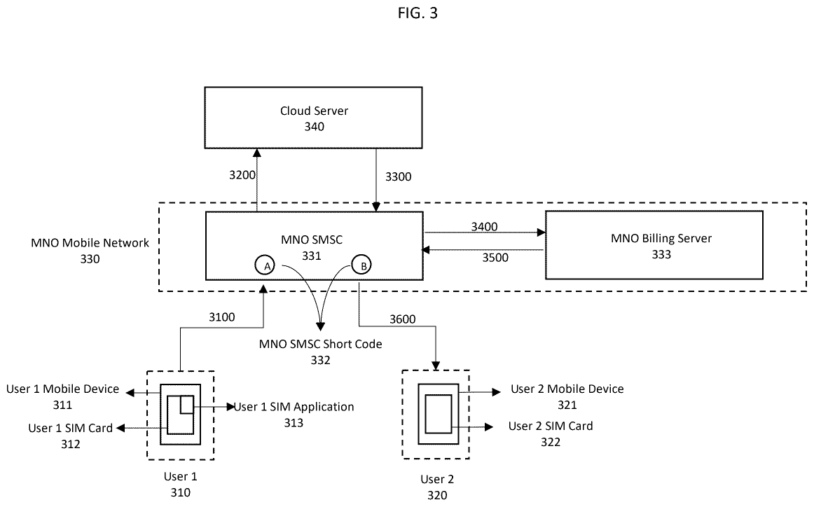

An embodiments of the structure of the system disclosed herein is illustrated in FIG. 3.

The System Structure of FIG. 3 comprises User 1 (310), which comprises User 1 Mobile Device (311), User 1 SIM Card (312), and SIM application (313), and User 2 (320), which comprises User 2 Mobile Device (321) and User 2 SIM Card (322), operably connected to MNO Mobile Network (330) that is operably connected to remote Cloud Server (340). MNO Mobile Network (330) comprises Mobile Network Operator Short Message Server Center (MNO SMSC) (331) and Mobile Network Operator Billing Server (MNO Billing Server) (333).

User 1 (310) comprises a User 1 Mobile Device (311) configured to connect to the MNO Mobile Network (330) with User 1 SIM Card (312). User 1 SIM application (313) is embedded software on User 1 SIM Card (312). User 1 SIM application (313) can also be loaded to User 1 SIM Card (312) via Over the Air (OTA) platform in some embodiments. User 1 SIM application (313) collects screen responses selected on User 1 Mobile Device (311) and converts them into software code to be sent to User 2 (320).

User 2 (320) comprises a User 2 Mobile Device (321) configured to connect to the Mobile Network (330) with a User 2 SIM Card (322).

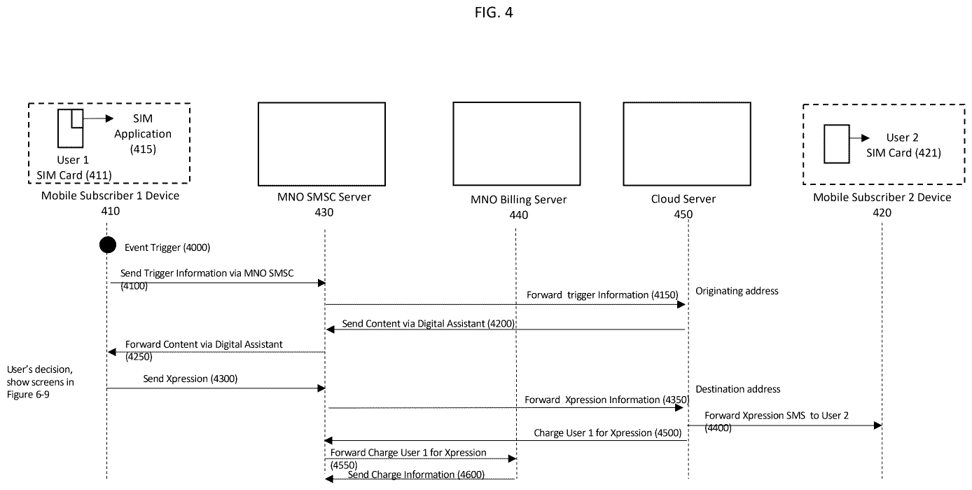

In an exemplary use of the system in FIG. 3, User 1 (310) calls User 2 (320). An end-of-call event is triggered when User 1 (310) or User 2 (320) terminates the call. When the call is terminated, the SIM application (313) detects that the call has disconnected or receives an indication that the call has disconnected. The SIM Application detects the triggering event, collects originating address and destination address and sends to the information to the Cloud Server. As shown in FIG. 4, the Cloud Server prepares the content for Mobile Subscriber 1 Device (410) and sends it to MNO SMSC Server (430) in Step 4200. The SIM Application causes content to be displayed on a screen on User 1 Mobile Device (311). The content comprises optional Xpression messages for selection to send to User 2 Mobile Device. The system can be configured to so the content can comprise six types of messages: emoji, quote, joke, message, uplifting message, or upcoming event. In some embodiments, the system can also be configured so the content comprises other messages including videos, video clips, music, games, pictures, and other similar content. Then, SIM application (313) collects the response selected on User 1 Mobile Device. SIM application (313) converts the response to proprietary software code to be sent to User 2 (320) via the Cloud Server (340). SIM Application (313) software is configured to communicate to the Cloud Server (340) via a SMSC Short Code (332), which is a specific destination address within Mobile Network Operator SMSC (331). In this example, “1234” is used as the SMSC Short Code (332) for the destination address at the Mobile Network Operator SMSC (331).

SIM application (313) packages the response selected on User 1 Mobile Device into a binary SMS message and a software code that correlates to the option collected by SIM application (313) along with the originating address (User 1's Mobile Phone Number) and the destination address (User 2's Mobile Phone Number) to the MNO SMSC (331) through the SMSC Short Code (332) 1234 at Point A in Step 3100. According to the systems design, MNO SMSC (331) automatically sends messages arriving at SMSC Short Code (332) 1234 at Point A to the Cloud Server (340) in Step 3200. In some embodiments, Cloud Server (340) reads the content of the message. In some embodiments, loud Server (340) needs additional information from User 1 Mobile Device and sends a follow-up message to User 1 Mobile Device wherein the message requires additional information. In certain embodiments, the additional information could be a request for confirmation to send the response selected. In other embodiments, the additional information could be a request to confirm acceptance of a price associated with sending the Xpression message. In other embodiments where Cloud Server (340) reads the contents, Cloud Server (340) stores the selected message option in a database account associated with the mobile device. In some embodiments, the Cloud Server (340) can communicate back with User 1 (310) or User 2 (320).

If the Cloud Server (340) needs to collect more information from User 1 (310), then a new screen content is prepared within Cloud Server (340) and packaged into a binary SMS message. Within this message, SIM application's (313) unique software number within SIM Tool Kit (STK) framework is also included. This message is sent to MNO SMSC (331) with destination address of User 1 (310), which could be the MSISDN associated with User 1 Mobile Device. MNO SMSC (331) receives the message at SMSC Short Code (332) 1234 at Point A and forwards the message to User 1 (310). When this message is received by User 1 Mobile Device (311), User 1 Mobile Device forwards the message to the SIM Tool Kit (STK) environment. The STK platform forwards the message to SIM application (313) by using the unique software number. Now, SIM application (313) is triggered. SIM application (313) processes the incoming message and displays screens on User 1 Mobile device (311).

In another embodiment, Cloud Server (340) sends the information from User 1 (310) to User 2 (320). Cloud Server (340) prepares a new screen and wraps it into an SMS message. This message is sent to MNO SMSC (331) with the destination address of User 2 (320), which, in some embodiments, is an MSISDN associated with User 2 Mobile Device in Step 3300. MNO SMSC (331) receives the message at SMSC Short Code (332) 1234 at Point B and forwards the message to User 2 (320) in Step 3600. When this message is received by User 2 Mobile Device (321), User 2 Mobile Device displays the message on a screen of User 2 Mobile Device (321). MNO SMSC (331) communicates with MNO Billing Server (333) that the message to User 2 was sent in Step 3400. MNO Billing Server (333) forwards the billing information (e.g., the account associated with User 1) to the MNO SMSC (331) for processing and User 1 (310) is charged for the message in Step 3500.

The trigger event that triggers the system can be configured to be other events besides a disconnected call. The trigger event described above can be initiated from other events. In some embodiments, a trigger event can be a visit to a specific web page. In some embodiments, the trigger can happen after User 1 and User 2 exchange messages within a social network. In some embodiments, the trigger can also be a Mobile Network Operator billing event. In some embodiments, the trigger can also be activated from an event within another MNO service or outside of Mobile Network Operator Network. In each case, the event will be forwarded to the Cloud Server (340) which in return communicates to the SIM application (313).

### Communication Process

The Communication Process is illustrated in FIGS. 4, 6, 7, 8, 9, 10, 11, 12, 13, and 14. The first digit of the number proceeding a component of the system correlates to the figure it is explained in. For example, all numbers that begin with “4” correlate to FIG. 4.

The communication process begins with an event trigger in Step 4000. In some embodiments, the trigger is a phone call, a disconnected phone call, a missed call, or an initial phone call followed by an electronic business card exchange, or a missed phone call followed by a text message. After a trigger event occurs, SIM application (415) sends a notification to the Cloud Server (450) using SMSC short codes as described in FIG. 3 MNO SMSC Short Code (332). The MNO SMSC server forwards communications with the specific short code to the Cloud Server (450) whether the communication comes from the originating address or the destination address.

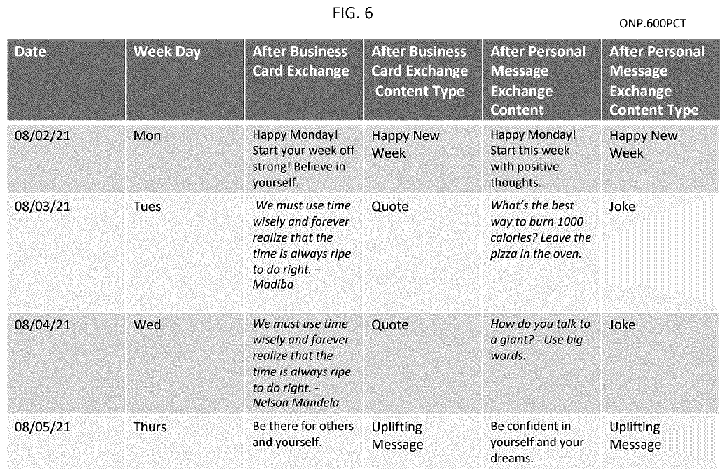

In some embodiments, Cloud Server accesses and checks a calendar. In some embodiments, the Cloud Server checks the calendar and the type of trigger event. In some embodiments, the Cloud Server comprises an Editorial Calendar (600) in FIG. 6 and Table 1. Editorial Calendar (600) includes embodiments of messages that can included in the plurality of message options depending on the trigger event and the date. In some embodiments, Cloud Server (450) may recognize the type of trigger event and will look at the corresponding type of trigger for that specific date. For example, if the User 1 sends an electronic business card to the last caller using service on Tuesday Aug. 3, 2021, Cloud Server can send certain types of emotive and contextual messages for User 1 Mobile Device to send to User 2 Mobile Device. If User 1 has sent a personalized message, then Cloud Server can propose different types of emotive and contextual messages to send.

TABLE 1

| | | | After | | After |
|---|---|---|---|---|---|
| | | | Business | | Personal |
| | | After | Card | After | Message |
| | | Business | Exchange | Personal | Exchange |
| | | Card | Content | Message | Content |
| Date | Week Day | Exchange | Type | Exchange | Type |
| Aug. 2, 2021 | Mon | Happy | Happy New | Happy | Happy New |
| | | Monday! | Week | Monday! | Week |
| | | Start your | | Start this | |
| | | week off | | week with | |
| | | strong! | | positive | |
| | | Believe in | | thoughts. | |
| | | yourself. | | | |
| Aug. 3, 2021 | Tues | We must use | Quote | What's the | Joke |
| | | time wisely | | best way to | |
| | | and forever | | burn 1000 | |
| | | realize that | | calories? | |
| | | the time is | | Leave the | |
| | | always ripe | | pizza in the | |
| | | to do right. - | | oven. | |
| | | Madiba | | | |
| Aug. 4, 2021 | Wed | We must use | Quote | How do you | Joke |
| | | time wisely | | talk to a | |
| | | and forever | | giant? - Use | |
| | | realize that | | big words. | |
| | | the time is | | | |
| | | always ripe | | | |
| | | to do right. - | | | |
| | | Nelson | | | |
| | | Mandela | | | |
| Aug. 5, 2021 | Thurs | Be there for | Uplifting | Be confident | Uplifting |
| | | others and | Message | in yourself | Message |
| | | yourself. | | and your | |
| | | | | dreams. | |

In some embodiments, the system can be configured to send six types of messages (emoji, quote, joke, message, uplifting message, or upcoming event). In some embodiments, the system can also be configured to send other messages including videos, video clips, music, games, pictures and other similar content. The process for sending any of these three types of messages is the same, although the content displayed to the user may differ.

After the trigger event, SIM Application (415) collects the information (originating address, MSISDN, and the destination address) and sends it to MNO SMSC Server (430) in Step 4100 via a SMSC short code as described in FIG. 3 MNO SMSC Short Code (332). Then, MNO SMSC Server (430) forwards this trigger information, along with the originating address and destination address, to Cloud Server (450) in Step 4150. Cloud Server (450) prepares the content for Mobile Subscriber 1 Device (410) and sends it to MNO SMSC Server (430) in Step 4200. MNO SMSC Server (430) receives the content and forwards it to Mobile Subscriber 1 Device (410) to display as a digital screen in Step 4250.

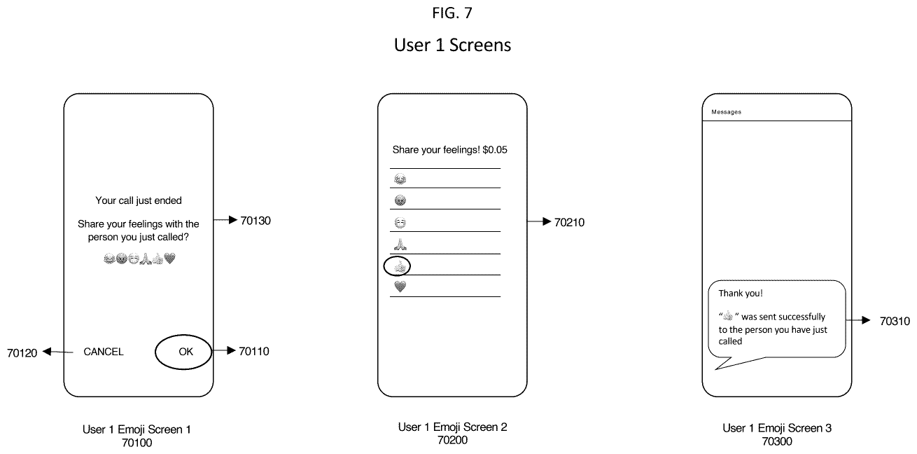

FIGS. 7, 8, 9, 10, 11 and 12 are graphical representation of the screens described herein. FIG. 7 shows an embodiment of screens for sharing an emoji in embodiments of the methods and systems disclosed herein. User 1 Emoji Screen 1 (70100) displays the message (70130) “Your call just ended. Share your feelings with the person you just called? [symbol] .” Screen 70100 includes Cancel option 70120 and OK option 70110. After OK 70110 is selected on Screen 70100, then the SIM Application causes User 1 Emoji Screen 2 (70200) to display message (70210) which reads: “Share your feelings! $0.05” and includes selectable emoji options “ [symbol] .” After a selectable emoji option is selected, SIM Application sends the information to the Cloud Server via an MNO SMSC. In some embodiments, after the emoji is sent, the SIM Application causes User 1 Emoji Screen 3 (70300) to display confirmation message (70310).

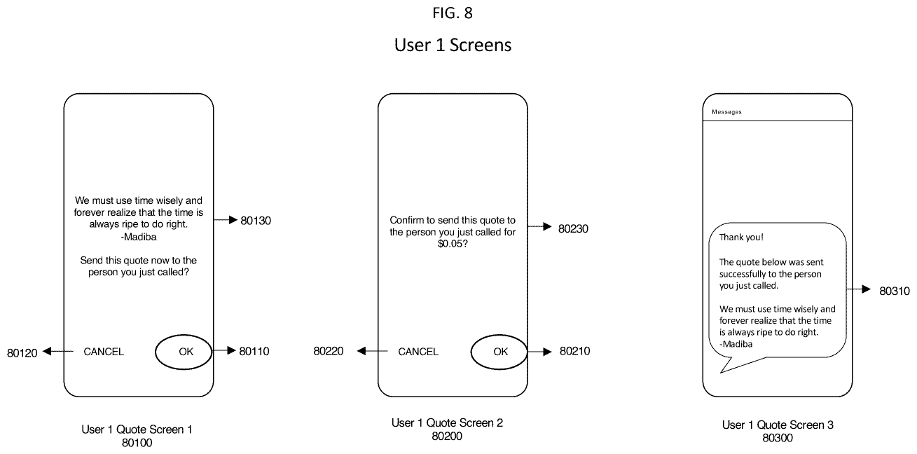

FIG. 8 shows an embodiment of screens for sharing an emoji in embodiments of the methods and systems disclosed herein. User 1 Quote Screen 1 (80100) displays the message (80130) which reads “We must use time wisely and forever realize that the time is always ripe to do right.—Madiba Send this quote now to the person you just called?” User 1 Quote Screen 80100 includes Cancel option 80120 and OK option 80110. After OK 80110 is selected on Screen 80100, then the SIM Application causes User 1 Quote Screen 2 (80200) to display. User 1 Quote Screen 2 (80200) includes message (80230) which reads: “Confirm to send this quote to the person you just called for $0.05?” User 1 Quote Screen 2 includes Cancel option 80220. After OK option 80210 is selected, SIM Application sends the selected quote to the Cloud Server via an MNO SMSC at step 80230. In some embodiments, after the quote is sent, the SIM Application causes User 1 Quote Screen 3 (80300) to display confirmation message (80310).

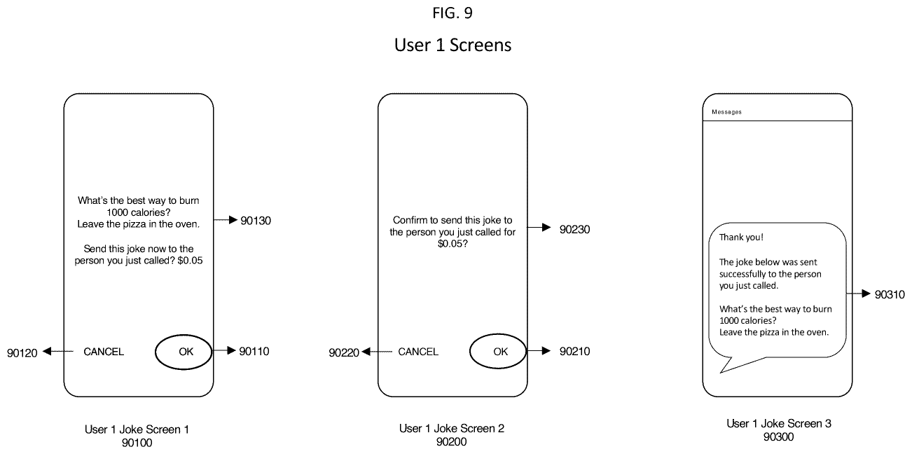

FIG. 9 shows an embodiment of screens for sharing a joke in embodiments of the methods and systems disclosed herein. User 1 Joke Screen 1 (90100) displays the message (90130) which reads “What's the best way to burn 1000 calories? Leave the pizza in the oven. Send this joke now to the person you just called for $0.05?” User 1 Joke Screen 90100 includes Cancel option 90120 and OK option 90110. After OK 90110 is selected on Screen 90100, then the SIM Application causes User 1 Joke Screen 2 (90200) to display message (90230) which reads: “Confirm to send this quote to the person you just called for $0.05?” User 1 Joke Screen 2 includes Cancel option 90220. After OK option 90210 is selected, the SIM Application sends the selected joke to the Cloud Server via an MNO SMSC. In some embodiments, after the joke is sent, the SIM Application causes User 1 Joke Screen 3 (90300) to display confirmation message (90310).

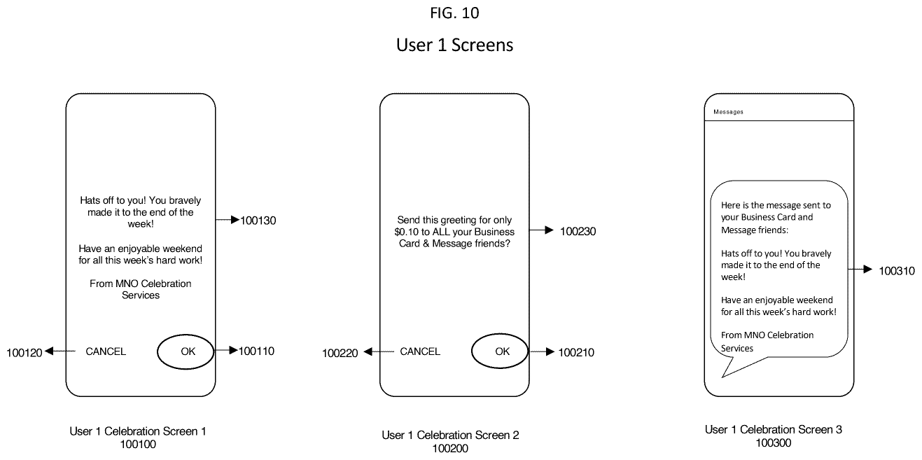

FIG. 10 shows an embodiment of screens for sharing a celebration message in embodiments of the methods and systems disclosed herein. User 1 Celebration Screen 1 (100100) displays the message (100130) which reads “Hats off to you! You bravely made it to the end of the week! Have an enjoyable weekend for all this week's hard work.” User 1 Celebration Screen 100100 includes Cancel option 100120 and OK option 100110. After OK 100110 is selected on Screen 100100, then the SIM Application causes User 1 Celebration Screen 2 (100200) to display message (100230) which reads: “Send this greeting for only $0.10 to ALL your Business Card to Message friends?” User 1 Celebration Screen 2 (100200) includes Cancel option 100220. After OK option 100210 is selected, the SIM Application sends the celebration message to the Cloud Server via an MNO SMSC. In some embodiments, after the celebration message is sent, the SIM Application causes User 1 Celebration Screen 3 (100300) to display confirmation message (100310).

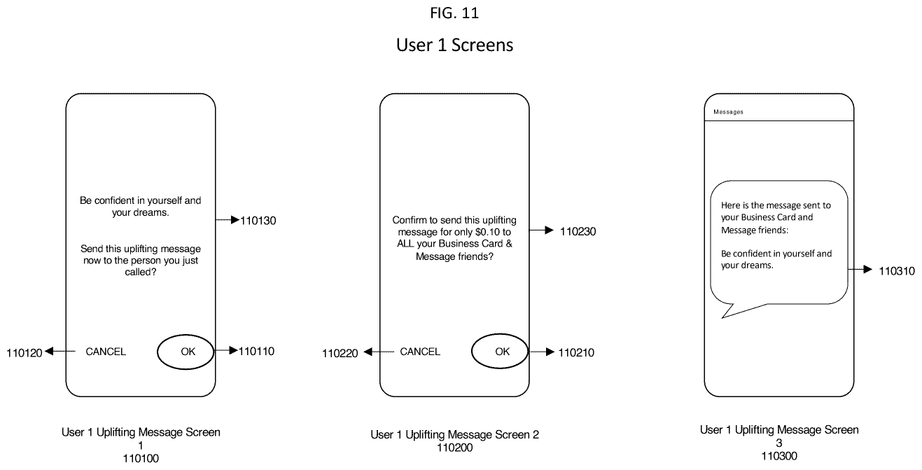

FIG. 11 shows an embodiment of screens for sharing an uplifting message in embodiments of the methods and systems disclosed herein. User 1 Uplifting Message Screen 1 (110100) displays the message (110130) which reads “Be confident in yourself and your dreams. Send this uplifting message now to the person you just called?” User 1 Uplifting Message Screen 110100 includes Cancel option 110120 and OK option 110110. After OK 110110 is selected on Screen 110100, then the SIM Application causes User 1 Uplifting Message Screen 2 (110200) to display message (110230) which reads: “Confirm to send this uplifting message for only $0.10 to ALL your Business Card & Message friends?” User 1 Uplifting Message Screen 2 (110200) includes Cancel option 110220. After OK option 110210 is selected, the SIM Application sends the uplifting message to the Cloud Server via an MNO SMSC. In some embodiments, after the uplifting message is sent, the SIM Application causes User 1 Uplifting Message Screen 3 (110300) to display confirmation message (110310).

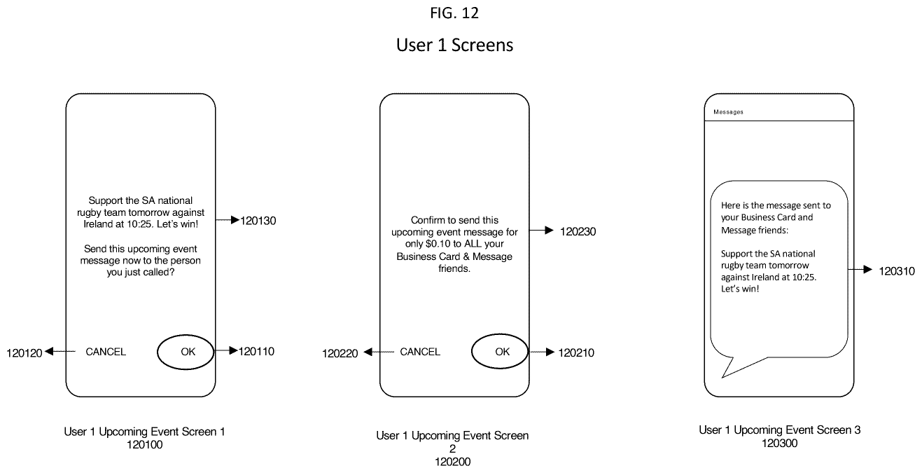

FIG. 12 shows an embodiment of screens for sharing an upcoming event in embodiments of the methods and systems disclosed herein. User 1 Upcoming Event Screen 1 (120100) displays the message (120130) which reads “Support the SA national rugby team tomorrow against Ireland at 10:25. Let's win! Send this upcoming event message now to the person you just called?” User 1 Upcoming Event Screen 120100 includes Cancel option 120120 and OK option 120110. After OK 120110 is selected on Screen 120100, then the SIM Application causes User 1 Upcoming Event Screen 2 (120200) to display message (120230) which reads: “Confirm to send this upcoming event message for only $0.10 to ALL your Business Card & Message friends.” User 1 Upcoming Event Screen 2 (120200) includes Cancel option 120220. After OK option 120210 is selected, the SIM Application sends the upcoming event message to the Cloud Server via an MNO SMSC. In some embodiments, after the upcoming event message is sent, the SIM Application causes User 1 Upcoming Event Screen 3 (120300) to display confirmation message (120310).

On the first User 1 Screens, when OK selected, the SIM Application collects the information and sends it to MNO SMSC Server (430), which forward the information to the Cloud Server (450). The Cloud Server (450) prepares the next screen and sends it to the MNO SMSC Server (430) to be forwarded to User 1 Mobile Device.

If “OK” is selected on the second User 1 screen, or an emoji is selected to send, the SIM Application collects this information and sends it to the MNO SMSC Server (430) via a SMSC Short Code in Step 4300 and the MNO SMSC Server (430) forwards the information to the Cloud Server (450) in step 4350.

Cloud Server (450) receives the selected option choice and formats the content to send to the destination address. Cloud Server (450) sends the message to the Mobile Subscriber 2 Device (420) via the MNO SMSC in step 4400. In some embodiments, the Cloud Server sends the message as an SMS.

In some embodiments, after the message is sent to the destination address, the Cloud Server (450) communicates with the MNO SMSC Server (430) that the message was sent successfully in Step 4500. In some embodiments, MNO SMSC Server (430) forwards the confirmation information to the MNO Billing Server (440) in Step 4550. The MNO Billing Server (440) then sends the billing information to the MNO SMSC Server (430) for processing in Step 4600.

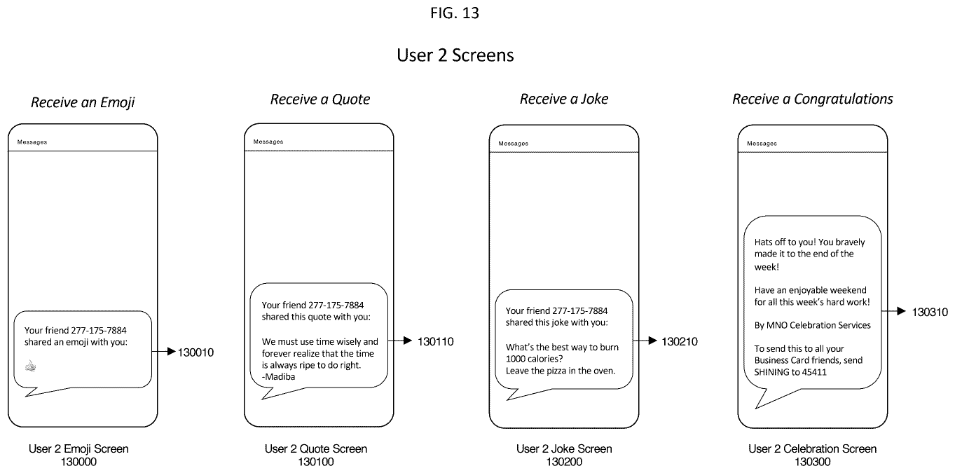

FIG. 13 shows embodiments of screens received by User 2 Mobile Device in embodiments of the methods and systems disclosed herein. User 2 Emoji Screen (130000) shows message (130010) comprising the shared emoji and the originating address of User 1. User 2 Quote Screen (130100) shows message (130110) comprising the shared quote and the originating address of User 1. User 2 Joke Screen (130200) shows message (13021) comprising the shared joke and the originating address of User 1. User 2 Celebration Screen (130300) shows message (130310) comprising the shared celebration message.

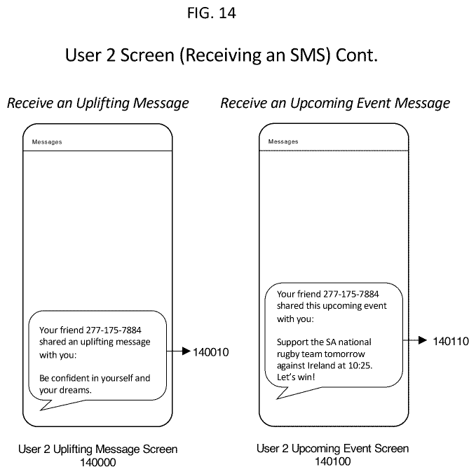

FIG. 14 shows embodiments of screens received by User 2 Mobile Device in embodiments of the methods and systems disclosed herein. User 2 Uplifting Message Screen (140000) shows message (140010) comprising the shared uplifting message and the originating address of User 1. User 2 Upcoming Event Screen (140100) shows message (140110) comprising the shared event message and the originating address of User 1.

### Interactive Cancel Survey Process

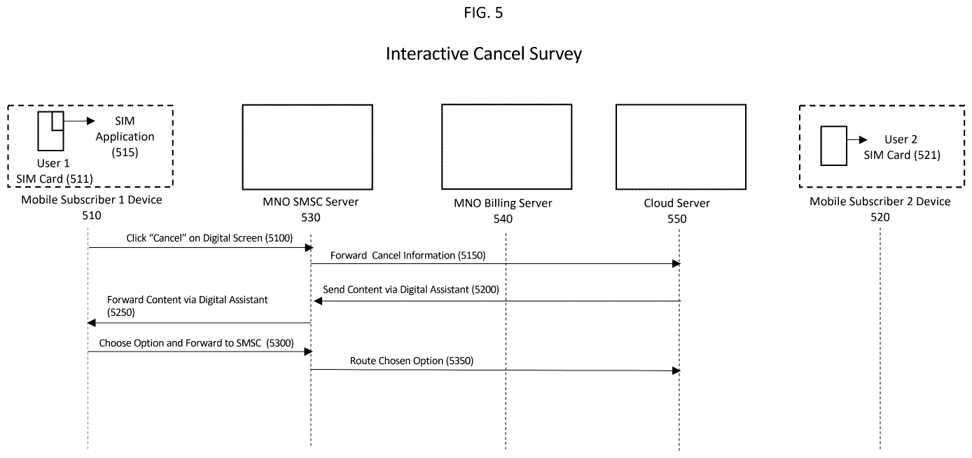

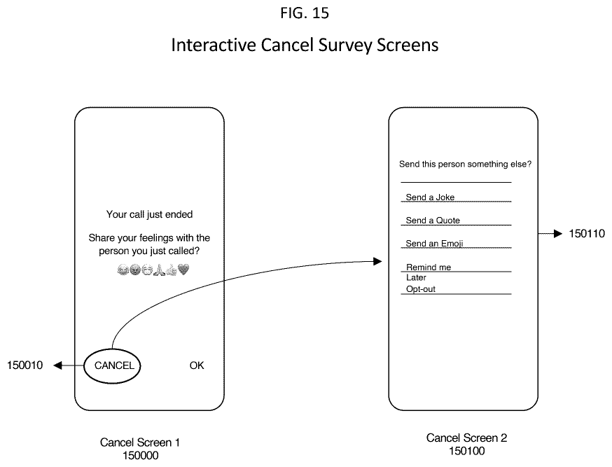

The Interactive Cancel Survey Process is described in FIGS. 5 and 15. Figure numbers that begin with “5” correlate to FIG. 5 and figure numbers that begin with “15” correlate to FIG. 15.

If “Cancel” is selected on either of the initial screens User 1 screens, the Communication System (300) in FIG. 3 can be configured to display an interactive cancel survey. The Cancel response is collected by the SIM Application (515) and sent to the MNO SMSC Server (530) in Step S100. MNO SMSC Server (530) sends the Cancel response to the Cloud Server (550) in Step S150. Cloud Server (550) creates the content for the cancel screens and sends it to MNO SMSC Server (530) in Step S200. Then, MNO SMSC Server (530) forwards the content via digital assistant to the Mobile Subscriber 1 Device (510) in Step S250.

FIG. 15 shows embodiments of screens for the interactive cancel methods and systems disclosed herein. Cancel Screen 1 (150000) is an exemplary User 1 screen showing emoji options and comprising Cancel option (150010). When Cancel option (150010) is selected, the SIM Application causes Cancel Screen 2 (150100) to display message (150110) which includes options to send something else and reads: “Send this person something else? | Send a Joke|Send a Quote|Send an Emoji|Remind me Later|Opt-out.”

When an option is selected on Cancel Screen 2, the SIM Application (515) collects the selected option and sends it to MNO SMSC Server (530) in step S300. MNO SMSC Server (530) sends the information to the Cloud Server (550) in Step S350. If “Send a Joke”, “Send a Quote”, or “Send an Emoji” is selected on Mobile Subscriber 1 Device, the Cloud Server (550) will restart the Communication Process for Mobile Subscriber 1 Device with the option selected. This will follow the same steps as the Communication Process described above. If “Remind me Later” is selected on Mobile Subscriber 1 Device, the Cloud Server will collect the information and will contact Mobile Subscriber 1 Device again for the same service the next day or at some other configurable later date. Mobile Subscriber 1 Device can opt-out of the entire service by clicking “Opt-out”. Once opt out is selected, Mobile Subscriber 1 Device will no longer be contacted about this service forever or for a configurable period of time.

The Communication System (300) in FIG. 3 can be configured to have the intelligence to predict which type of Xpression Mobile Subscriber 1 Device may want to send. The Cloud Server (550) will have the ability to collect options selected and, by analyzing patterns and with whom Mobile Subscriber 1 Device communicates, will be able to predict options likely to be selected on Mobile Subscriber 1 Device and offer the most accurate message preference to Mobile Subscriber 1 Device. For example, “Cancel” is consistently selected on Mobile Subscriber 1 Device jokes are offered, the Cloud Server (550) will recognize this behavior and will reduce the amount of joke offers it sends to Mobile Subscriber 1 Device. For example, Communication System (100) in FIG. 1 may change its output to only send one joke offer for every twenty uses. In another example, if quotes are frequently selected on Mobile Subscriber 1 Device, the Cloud Server (550) can be configured to offer more quote options to Mobile Subscriber 1 Device.

### Cloud Server Intelligence:

Cloud Server (340) described in FIG. 3 and other Figures in this document, may be designed to have different levels of intelligence. Cloud Server (340) can be programmed in such a way that it collects the User 1 (310) and User 2 (320) user decisions from the screens of User 1 Mobile Device (311) and User 1 Mobile Device (321). This information can be stored in a database coupled with the Cloud Server (340). For example, when User 1 (310) is prompted to choose between an emoji, quote, joke, message, uplifting message, or upcoming event, the User 1 (310) decision can be stored within the Cloud Server (340) and within a connected database. For example, if the User 1 (310) chooses “Cancel” on the screen for joke offer more than three times, this decision is collected within Cloud Server (340) and within a connected database. Cloud Server (340) can be designed such that User 1 (310) will not be prompted again with a “send a joke” offer next time there is an event trigger. In this case, User 1 (310) may be offered with a different type of offer such as an emoji, quote, message, uplifting message, or upcoming event. Cloud Server (340) can be designed such that Users can be prompted for only the offers they like to send to others.

User 1 (310) offers can be organized such that prior User 1 (310) choices dictates what User 1 (310) will experience. For example, if User 1 (310) chooses to send a Happy New Year message to User 2 (320) on Jan. 1, 2021 of that year, on that specific day, User 1 (310) may be prompted to send Happy New Year message to all contacts of User 1 (310) after each trigger that day. The system can also be designed such that Cloud Server (340) remembers User 1 (310) selections on the same day next year (Jan. 1, 2022). The next year on that day, the service will prompt User 1 (310) to send Happy New Year message to all User 1 (310) contacts after each trigger event. In summary, Cloud Server (340) can be designed in such a way that it remembers the correlation in between the Xpression Editorial Calendar (600), the available message content, date of the event and decisions made by User 1 (310). Through this correlation, the offers are suggested intelligently to User 1 (310) after each event trigger.

What is claimed is:

1. A system for automatically sending a plurality of expressive message options after a call from a mobile device to a second mobile device has disconnected, comprising:
a SIM application installed on a SIM card of the mobile device and configured to:
detect that, or receive an indication that, a call from the mobile device to the second mobile device has disconnected;
prepare a communication comprising the originating address of the mobile device, the destination address of the second mobile device, and an SMSC short code; and
send the communication to a cloud server operably connected to a Mobile Network Operator's (MNO) network via a Short Message Service Center;
a Short Message Service Center (SMSC) operably connected to the MNO's network and configured to:
send the communication to a cloud server operably connected to the SMSC;
send to the mobile device a message received from the cloud server;
receive a second communication from the SIM application, the second communication comprising a selected expressive message option selected on the mobile device; and
send the second communication comprising the selected expressive message to the cloud server or to the second mobile device;
a cloud server operably connected to the SMSC and configured to:
generate a plurality of selectable expressive message options, wherein each expressive message option is an emoji, quote, uplifting message, or event information;
prepare a message comprising the plurality of selectable expressive message options and instructions for the SIM application to cause a menu comprising the selectable expressive message options to be displayed on a screen of the mobile device; and
send the message to the SMSC; and
a billing server operably connected to the SMSC and configured to charge an amount to an account associated with the mobile device when an expressive message is sent to the second mobile device.

2. The system of claim 1, wherein the cloud server is further configured to check a calendar and include a calendar-related message option in the plurality of selectable expressive message options.

3. The system of claim 1, wherein the cloud server is further configured to determine if a previous expressive message has been sent from the mobile device to the second mobile device.

4. The system of claim 4, wherein, when an expressive message has previously been sent from the mobile device to the second mobile device, the cloud server is further configured to include the previously sent expressive message in the plurality of selectable expressive message options.

5. The system of claim 1, wherein the cloud server is further configured to determine whether the mobile device has opted into receiving the plurality of selectable expressive message options from the cloud server.

6. A method of automatically sending automatically sending a plurality of expressive message options after a call from a mobile device to a second mobile device has disconnected, comprising:
receiving, at Short Messaging Service Center (SMSC), a communication from a SIM application on the mobile device, the communication comprising the originating address of the mobile device, the destination address of the second mobile device, and an SMSC short code;
sending, from the SMSC, the communication to a cloud server operably connected to the SMSC;
generating, at the cloud server, a plurality of selectable expressive message options, wherein each selectable expressive message option is an emoji, quote, uplifting message, or event information;
preparing, at the cloud server, a message comprising the plurality of selectable expressive message options and instructions for the SIM application to cause a menu comprising the selectable expressive message options to be displayed on a screen of the mobile device; and
sending, from the cloud server, the message to the SMSC;
sending, from the SMSC, the message to the mobile device;
receiving, at the SMSC, a second communication from the mobile device, the second communication comprising a selected expressive message option selected on the mobile device; and
sending, from the SMSC, the second communication comprising the selected expressive message to the cloud server or to the second mobile device; and
generating, at a billing server operably connected to the SMSC, an account charge for an account associated with the mobile device when an expressive message is sent to the second mobile device.

7. The method of claim 6, further comprising checking, by the cloud server, a calendar and including a calendar-related message option in the plurality of selectable expressive message options.

8. The method of claim 6, further comprising determining, by the cloud server, whether a previous expressive message has been sent from the mobile device from the second mobile device.

9. The method of claim 8, further comprising including a previously sent expressive message in the plurality of selectable expressive message options when the cloud server determines that an expressive message has been previously sent from the mobile device to the second mobile device.

10. The method of claim 6, further comprising determining, by the cloud server, whether the mobile device has opted into receiving the plurality of selectable expressive message options.

11. A method for providing emotive and contextual messaging to mobile devices in a mobile network, the method comprising the steps of:
receiving trigger information at a Cloud Server from an Operator SMSC Server relating to a first mobile device;
sending content to the first mobile device via a digital assistant from the Cloud Server to the Operator SMSC Server;
receiving an Xpression from the first mobile device at the Cloud Server from the Operator SMSC server; and
forwarding the Xpression from the Cloud Server to a second mobile device.

12. The method of claim 11, further comprising the step of sending a request to charge the first mobile device for the Xpression to the Operator SMSC server.

13. The method of claim 11, further comprising receiving cancel information from the Operator SMSC server.

14. The method of claim 13, further comprising the step of forwarding content via a digital assistant to a first mobile device.

15. A system for providing emotive and contextual messaging to one or more mobile devices in a mobile network, the system comprising:
a Cloud Server, wherein the cloud server is communicatively coupled to a mobile network;
an Operator Billing Server, wherein the Operator Billing Server is communicatively coupled to the Cloud Server via the mobile network; and
the Operator SMSC Server, wherein the Operator SMCS server is connected to the Cloud Server via the mobile network.

16. The system of claim 15, further comprising a first mobile device comprising a first SIM card and a digital assistant, wherein the first mobile device is communicatively coupled to a mobile network.

17. The system of claim 15, wherein the Operator SMSC Server further comprises a SMSC short code.

18. The system of claim 15, wherein the Cloud Server is configured to communicate with a SIM application residing on a SIM card in a mobile device.
